(19) United States
(12) Patent Application Publication
(10) Pub. No.: US 2016/0011747 A1
(43) Pub. Date: Jan. 14, 2016

(54) WEB PAGE THUMBNAILS

(71) Applicant: INTERNATIONAL BUSINESS MACHINES CORPORATION, Armonk, NY (US)

(72) Inventors: Eric M. Brown, RALEIGH, NC (US); EDWARD V. BUSCH, RALEIGH, NC (US); AL CHAKRA, APEX, NC (US); SAURABH GUPTA, MORRISVILLE, NC (US); JOSEPH F. PESOT, CARY, NC (US); NANCY A. SCHIPON, APEX, NC (US)

(21) Appl. No.: 14/328,340

(22) Filed: Jul. 10, 2014

(51) Int. Cl. G06F 3/0484

(52) U.S. Cl. CPC G06F 3/04845; G06F 3/04847

(57) ABSTRACT

A method and system are provided. The method includes providing an extensible web page thumbnail widget library having a core set of web page thumbnail widgets. The widgets are for at least one of creating and modifying configurable web page thumbnails. The method further includes providing an extensible web page thumbnail framework for at least one of creating and modifying web page thumbnails using a user input hardware device and the widgets in the library.

### BACKGROUND

1. Technical Field

The present invention relates generally to the images and, in particular, to web page thumbnails.

2. Description of the Related Art

Thumbnails are reduced size versions of pictures used to get a quick snapshot of the pictures. The snapshots help users to quickly recognize them which then help in a number of ways including, for example, to organize them, to find a particular image, and so forth.

Web page thumbnails are a reduced size version of original web pages that give users a quick snapshot of the original web pages. They are widely used by a number of web browsers today.

There are many existing issues with today's web page thumbnails as they relates to user experience. These issues create a wide gap between the potential value of web page thumbnails and the actual value provided today.

Some of the existing issues including the following: being low on information and high on data; a lack of flexibility; and a lack of extensibility.

Regarding the first limitation, namely being low on information and high on data, we note that simply providing a smaller snapshot of the original web page many times produces an image with unreadable text. For this reason, the typical web page thumbnail provides snapshots of little value.

Regarding the second limitation, namely a lack of flexibility, there is very little customization that a user can do with web page thumbnails content and display. The snapshot content that a user would like to view from websites will vary with each user.

Regarding the third limitation, namely a lack of extensibility, there is no existing web page thumbnail framework where website owners can develop specific content for their website thumbnails and use it as a marketing tool. Similarly, end users have no control on how they can customize thumbnails of different websites to provide valuable information which will vary from user to user.

All the listed factors contribute in restricting the enormous value that the web page thumbnails can provide to a user.

### SUMMARY

According to an aspect of the present principles, a method is provided. The method includes providing an extensible web page thumbnail widget library having a core set of web page thumbnail widgets. The widgets are for at least one of creating and modifying configurable web page thumbnails. The method further includes providing an extensible web page thumbnail framework for at least one of creating and modifying web page thumbnails using a user input hardware device and the widgets in the library.

According to another aspect of the present principles, a system is provided. The system includes an extensible web page thumbnail widget library generator, having a processor, for generating an extensible web page thumbnail widget library having a core set of web page thumbnail widgets. The widgets are for at least one of creating and modifying configurable web page thumbnails. The system further includes an extensible web page thumbnail framework for at least one of creating and modifying web page thumbnails using a user input hardware device and the widgets in the library.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system 100 to which the present principles may be applied, in accordance with an embodiment of the present principles;

FIG. 2 shows an exemplary web page thumbnail management system 200, in accordance with an embodiment of the present principles; and

FIGS. 3-4 show an exemplary method 300 for providing a web page thumbnail management system, in accordance with an embodiment of the present principles.

### DETAILED DESCRIPTION OF PREFERRED EMBODIMENTS

The present principles are directed to web page thumbnails.

In an embodiment, the present principles can be considered to include at least the following two components: an extensible widget library relating to web page thumbnails; and a framework that allows users to design their own customizable web page thumbnails.

In an embodiment, the extensible widget library can advantageously provide one or more sets of core customizable widgets. In an embodiment, the extensible widget library can advantageously allow Website owners or other users to create their own widgets for contributing to the widget library. It is to be appreciated that the allowing of users to create their own widgets and contribute to the widget library advantageously makes the widget library itself highly extensible.

In an embodiment, the aforementioned framework advantageously allows a user to drag and drop widgets to their web page thumbnails. In an embodiment, the framework advantageously allows the user to resize web page thumbnails. In an embodiment, the framework advantageously allows a user to customize the number and type of widgets present on the thumbnails as well as the positioning and sizing of the individual widgets within a thumbnail group widget.

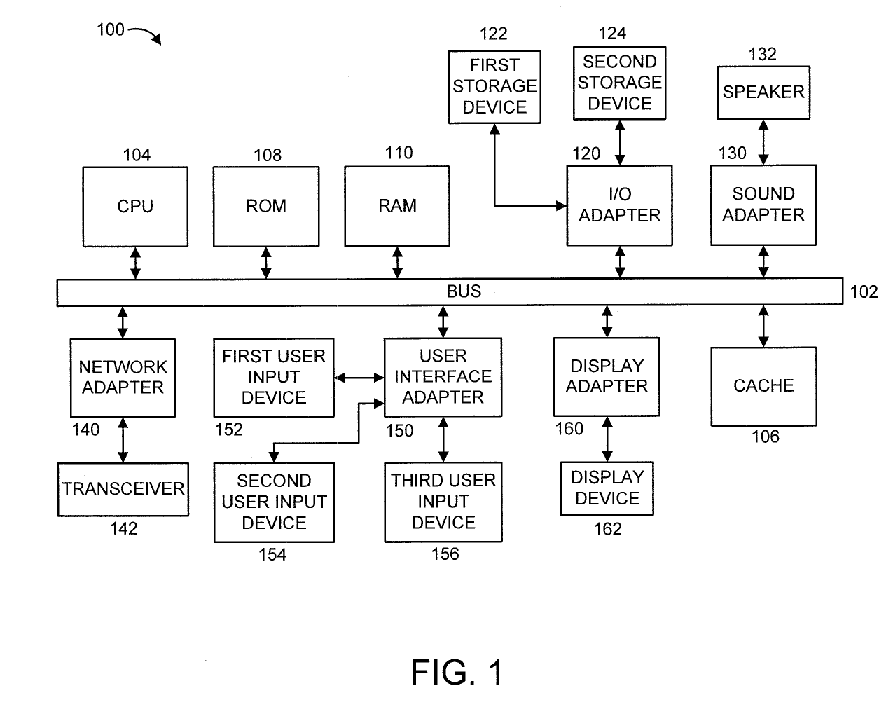

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operative coupled to system bus 102 by the sound adapter 130.

A transceiver 142 is operatively coupled to system bus 102 by network adapter 140.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

A display device 162 is operatively coupled to system bus 102 by display adapter 160.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

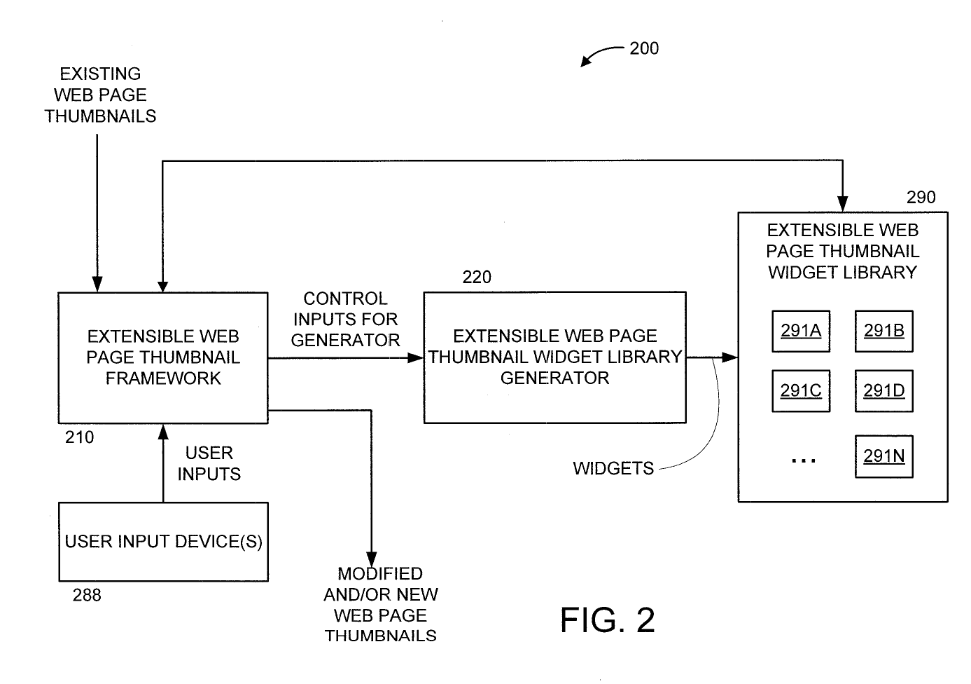

Moreover, it is to be appreciated that system 200 described below with respect to FIG. 2 is a system for implementing respective embodiments of the present principles. Part or all of processing system 100 may be implemented in one or more of the elements of system 200.

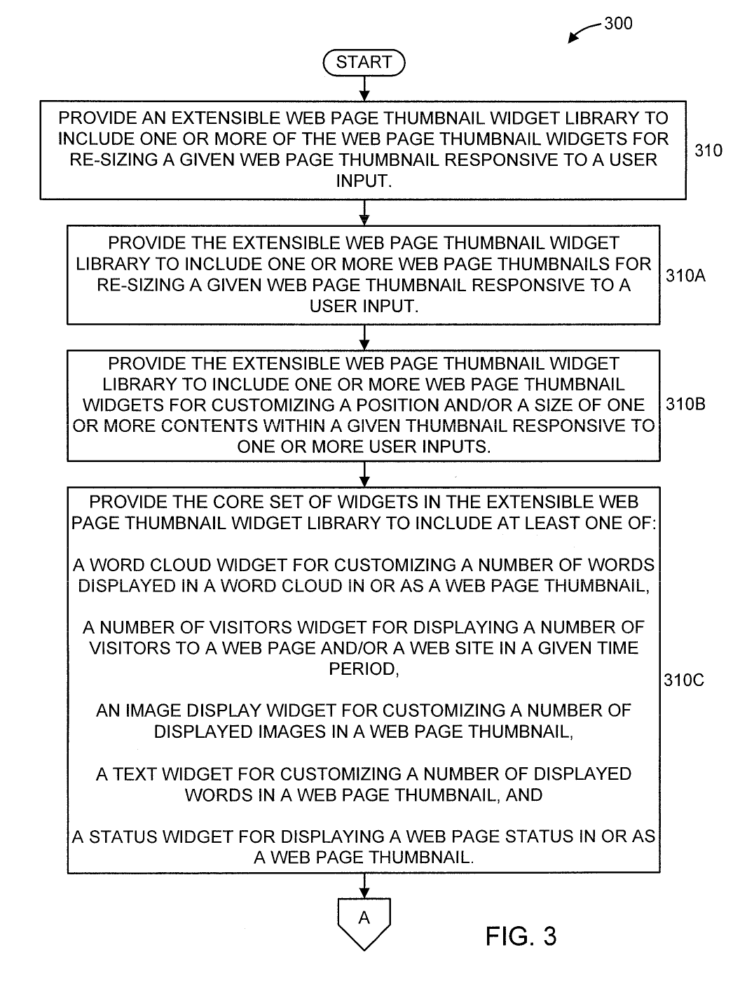

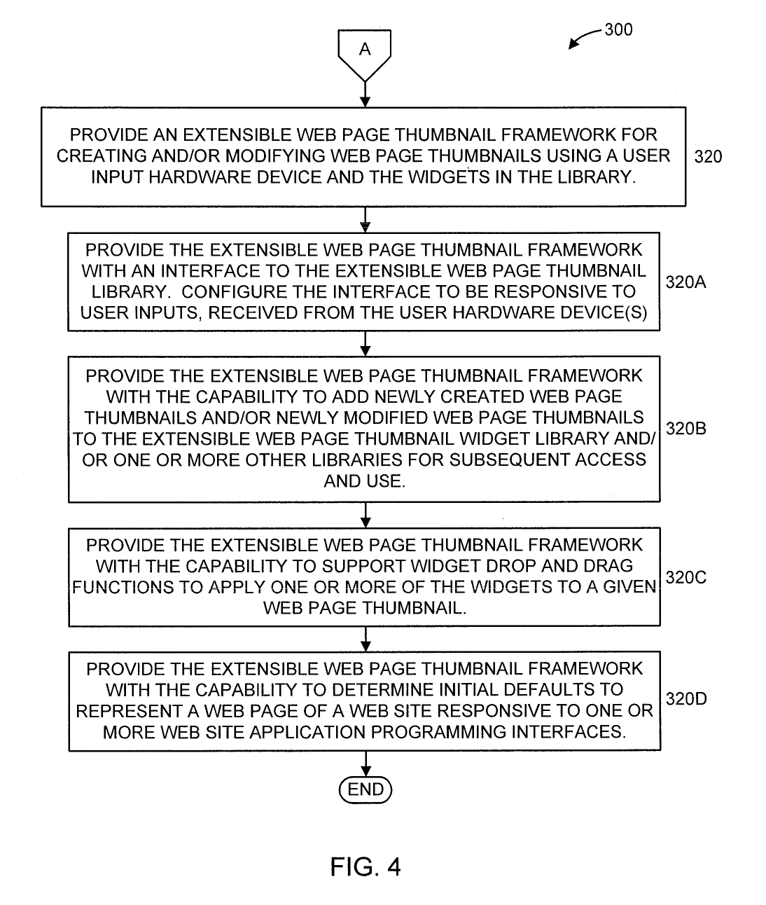

Further, it is to be appreciated that processing system 100 may perform at least part of the method described herein including, for example, at least part of method 300 of FIGS. 3-4. Similarly, part or all of system 200 may be used to perform at least part of method 300 of FIGS. 3-4.

FIG. 2 shows an exemplary web page thumbnail management system 200, in accordance with an embodiment of the present principles. The system 200 includes an extensible web page thumbnail widget library generator 210 and an extensible web page thumbnail framework 220.

The extensible web page thumbnail widget library generator 210 generates an extensible web page thumbnail widget library 290 having a core set of web page thumbnail widgets 291A-291N. The widgets are for at least one of creating and modifying configurable web page thumbnails. Various embodiments of the extensible web page thumbnail widget library generator 210 will at least involve a processor and corresponding memory. These and other embodiments of the extensible web page thumbnail widget library generator 210 are readily determined by one of ordinary skill in the art given the teachings of the present principles provided herein, while maintaining the spirit of the present principles.

The extensible web page thumbnail framework 220 is for creating and/or modifying web page thumbnails using a user input hardware device and the widgets in the library. In an embodiment, the extensible web page thumbnail framework 220 can include one or more of a library, a plug-able extension, an executable with an application programming interface (API), and a graphical user interface (GUI). Thus, the extensible web page thumbnail framework 220 receives user inputs via one or more user input hardware devices 288 (e.g., including, but not limited to, a mouse, a keyboard, and so forth). Some exemplary user input hardware devices such as the preceding are shown and described with respect to FIG. 1. The extensible web page thumbnail framework 220 then uses these inputs to control the extensible web page thumbnail widget library generator 210 to generate various widgets for the extensible web page thumbnail widget library 290. Also, the extensible web page thumbnail framework 220 can receive user inputs for modifying and performing other actions on existing web page thumbnail widgets as well as web page thumbnails. Thus, the extensible web page thumbnail framework 220 can receive existing web page thumbnails for modification, or can generate new web page thumbnails using the extensible web page thumbnail widget library 290.

Various embodiments of the extensible web page thumbnail framework 220 will at least involve a processor and corresponding memory. In an embodiment, the extensible web page thumbnail framework 220 utilizes web site APIs to determine initial defaults to represent a main page of the web site. These and other embodiments of the extensible web page thumbnail framework 220 are readily determined by one of ordinary skill in the art given the teachings of the present principles provided herein, while maintaining the spirit of the present principles.

FIGS. 3-4 show an exemplary method 300 for providing a web page thumbnail management system, in accordance with an embodiment of the present principles.

At step 310, provide an extensible web page thumbnail widget library having a core set of web page thumbnail widgets. The widgets are for at least one of creating and modifying configurable web page thumbnails. In an embodiment, step 310 can include one or more of steps 310A-310C.

At step 310A, provide the extensible web page thumbnail widget library to include one or more web page thumbnail widgets for re-sizing a given web page thumbnail responsive to a user input.

At step 310B, provide the extensible web page thumbnail widget library to include one or more web page thumbnail widgets for customizing a position and/or a size of one or more contents within a given thumbnail responsive to one or more user inputs.

At step 310C, provide the core set of widgets in the extensible web page thumbnail widget library to include at least one of a word cloud widget for customizing a number of words displayed in a word cloud in or as a web page thumbnail, a number of visitors widget for displaying a number of visitors to a web page and/or a web site in a given time period, an image display widget for customizing a number of displayed images in a web page thumbnail, a text widget for customizing a number of displayed words in a web page thumbnail, and a status widget for displaying a web page status in or as a web page thumbnail.

At step 320, provide an extensible web page thumbnail framework for creating and/or modifying web page thumbnails using a user input hardware device(s) and the widgets in the library. In an embodiment, step 320 can include one or more of steps 320A-320D.

At step 320A, provide the extensible web page thumbnail framework with an interface to the extensible web page thumbnail widget library. Configure the interface to be responsive to user inputs, received from the user input hardware device(s), for creating and/or modifying web page thumbnails using one or more of the widgets.

At step 320B, provide the extensible web page thumbnail framework with the capability to add newly created web page thumbnails and/or newly modified web page thumbnails to the extensible web page thumbnail widget library and/or one or more other libraries for subsequent access and use.

At step 320C, provide the extensible web page thumbnail framework with the capability to support widget drop and drag functions to apply one or more of the widgets to a given web page thumbnail.

At step 320D, provide the extensible web page thumbnail framework with the capability to determine initial defaults to represent a web page of a web site responsive to one or more web site application programming interfaces.

While described with respect to certain widgets with certain capabilities, it is to be appreciated that various embodiments of the present principles can include these and other widgets with other capabilities, as readily contemplated by one of ordinary skill in the art given the teachings of the present principles provided herein, while maintaining the spirit of the present principles.

For illustrative purposes, various exemplary proposed widgets for the aforementioned widget library will now be described. However, it is to be appreciated that, given the teachings of the present principles provided herein, one of ordinary skill in this and related arts will contemplate these and various other widgets in accordance with the teachings of the present principles while maintaining the spirit of the present principles.

In an embodiment, a “word/tag cloud” widget is proposed. The word/tag cloud widget can be for keywords on a main web page (or other web page). In an embodiment, the user can customize the number of words to be displayed in the word cloud.

In an embodiment, a “number of visitors” widget is proposed. The number of visitors widget can quantify the number of visitors to a web page or a website in a given time frame. For example, the number of visitors widget can quantify the number of visitors to a web page or a website in the last X number of years, months, weeks, days, minutes, and so forth, where X is an integer.

In an embodiment, an “image display widget” is proposed. The user can customize the number of images and which images are to be displayed by selecting from a list of images. In an embodiment, the list is an ordered list. The ordering can pertain to the images themselves or the number of images. For example, the images can be numbered to facilitate quickly finding a previously used and/or intended image. Ordering can be based on, for example, but is not limited to, the following: highest number to lowest; lowest number to highest; starting at a default value and either increment, decrementing or both with respect to the default number value or default starting image; and so forth.

In an embodiment, a “text widget” is proposed. The user can customize the number of words on the widget by selecting from a list of words. In an embodiment, the list can be an ordered list. The ordering can pertain to the words themselves or the number of words. For example, the words can be numbered to facilitate quickly finding a previously used and/or intended word. Ordering can be based on, for example, but is not limited to, the following: highest number to lowest; lowest number to highest; starting at a default value and either increment, decrementing or both with respect to the default number value or default starting word; and so forth. In an embodiment, different sets of words can be used, with each set having some feature in common, such as text size, font, and so forth.

In an embodiment, a “status widget” is proposed. The status widget can indicate certain statuses including, but not limited to, if the page has moved, when the page was moved, if the page no longer exists, when the page was removed, if the page was updated, when the page was (e.g., last) updated, and so forth.

A description will now be given of some exemplary scenarios to which the present principles can be applied, in accordance with various illustrative embodiments of the present principles.

In an embodiment, the present principles can be used for a technical (“tech” in short) website. In an embodiment, such a tech website can be directed to those interested in tech content (e.g., major headlines) and tech buzz words. Various embodiments of the present principles can enable detection of whether there is more than normal number of visitors, which might indicate a special scenario/news which is attracting more users.

In an embodiment, the present principles can be used for an internal company website. In an embodiment, such an internal company website can be directed to those interested in company related content and company related buzz words. Various embodiments of the present principles can indicate various statuses of the website and its pages/content including, but not limited to, if a page has moved, been removed, updated, and so forth.

In an embodiment, the present principles can be used for a news website. In an embodiment, such a news website can be directed to those interested in tech content (e.g., major headlines) and tech buzz words. Various embodiments of the present principles can indicate include various news orientated configurations. In an embodiment, there can be one main image. In an embodiment, the present principles can be used for a paintings website. The web page thumbnails can include thumbnails for a few (or more) main page images. Of course, web page thumbnails can be generated for non-main page images. Moreover, other configurations and other numbers of images can also be used.

In an embodiment, the present principles can be used for a paintings website. The web page thumbnails can include thumbnails for a few (or more) main page images. Of course, web page thumbnails can be generated for non-main page images. Moreover, other configurations and other numbers of images can also be used.

Embodiments of the present principles can provide at least the following advantages, as well as other advantages, as readily recognized by one of ordinary skill in the art, given the teachings of the present principles provided herein.

One advantage is value addition. For example, the thumbnails can change from “high in data, low in information” to “low in data, high in information”, thus providing a lot of useful information to the users through the snapshot.

Another advantage is flexibility. For example, users can customize the thumbnail based on their needs.

Yet another advantage is extensibility. For example, applying the concept of an extensible widget library to a web page thumbnail domain provides the advantage of extensibility and also adds a lot of value.

A description will now be given of the business value of the present principles. From a perspective of technology providing value to users in their daily life issues, the present principles advantageously enable the providing of value to customers by providing them useful and important information in the web page snapshot thus helping also the business owner further their business. From an industry perspective, the present principles will be of interest to, and provide many advantages, to at least the following: web browser owners; website owners/developers; and end users.

Regarding web browser owners, if integrated with any of the existing web browser clients, the present principles will provide an advantage over the web browser owners' competitors.

Regarding website owners/developers, the same can start viewing thumbnails as a marketing tool for their website and the widget library as a medium to get that marketing information out to customers. As an example, one such set of developers could be from some websites themselves which would like to create some widgets for their individual websites, knowing that the information present on that widget and if used on their web page snapshot would attract more customers.

Regarding end users, the same can add a lot of value to their web page thumbnails by developing their own widgets or customizing the website provided widgets or any other existing widgets.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method, comprising:
providing an extensible web page thumbnail widget library having a core set of web page thumbnail widgets, the widgets for at least one of creating and modifying configurable web page thumbnails; and
providing an extensible web page thumbnail framework for at least one of creating and modifying web page thumbnails using a user input hardware device and the widgets in the library.

2. The method of claim 1, wherein providing the extensible web page thumbnail framework comprises providing an interface to the extensible web page thumbnail widget library, the interface being responsive to user inputs, received from the user input hardware device, for at least one of creating and modifying web page thumbnails using one or more of the widgets.

3. The method of claim 1, wherein the user input hardware device comprises at least one of a mouse, a keyboard, a microphone, a track pad, a touchscreen, and a camera.

4. The method of claim 1, further comprising adding at least one of newly created web page thumbnail widgets and newly modified web page thumbnail widgets to the library.

5. The method of claim 1, wherein one or more of the web page thumbnail widgets re-size a given web page thumbnail responsive to a user input.

6. The method of claim 1, wherein one or more of the web page thumbnail widgets customize at least one of a position and a size of one or more contents within a given thumbnail responsive to one or more user inputs.

7. The method of claim 1, further comprising adding at least one of newly created web page thumbnails and newly modified web page thumbnails to at least one of the library or another library for subsequent access and use.

8. The method of claim 1, wherein the extensible web page thumbnail framework comprises at least one of a library, a plug-able extension, an executable with an application programming interface, and a graphical user interface.

9. The method of claim 1, wherein the extensible web page thumbnail framework supports widget drop and drag functions to apply one or more of the widgets to a given web page thumbnail.

10. The method of claim 1, wherein the extensible web page thumbnail framework determines initial defaults to represent a web page of a web site responsive to one or more web site application programming interfaces.

11. The method of claim 1, wherein each of widgets in the core set relate a web page thumbnail to be at least one of created and modified, the core set comprising at least one of a word cloud widget for customizing a number of words displayed in a word cloud in or as the web page thumbnail, a number of visitors widget for displaying a number of visitors to at least one of a web page and a web site in a given time period, an image display widget for customizing a number of displayed images, a text widget for customizing a number of displayed words, and a status widget for displaying a web page status.

12. A non-transitory article of manufacture tangibly embodying a computer readable program which when executed causes a computer to perform the steps of claim 1.

13. A system, comprising:
an extensible web page thumbnail widget library generator, having a processor, for generating an extensible web page thumbnail widget library having a core set of web page thumbnail widgets, the widgets for at least one of creating and modifying configurable web page thumbnails; and
an extensible web page thumbnail framework for at least one of creating and modifying web page thumbnails using a user input hardware device and the widgets in the library.

14. The system of claim 13, wherein the extensible web page thumbnail framework comprises an interface to the extensible web page thumbnail widget library, the interface being responsive to user inputs, received from the user input hardware device, for at least one of creating and modifying web page thumbnails using one or more of the widgets.

15. The system of claim 13, wherein the user input hardware device comprises at least one of a mouse, a keyboard, a microphone, a track pad, a touchscreen, and a camera.

16. The system of claim 13, wherein the extensible web page thumbnail widget library generator adds at least one of newly created web page thumbnail widgets and newly modified web page thumbnail widgets to the library.

17. The system of claim 13, wherein the extensible web page thumbnail widget library generator generates one or more of the web page thumbnail widgets to re-size a given web page thumbnail responsive to a user input.

18. The system of claim 13, wherein the extensible web page thumbnail widget library generator generates one or more of the web page thumbnail widgets to customize at least one of a position and a size of one or more contents within a given thumbnail responsive to one or more user inputs.

19. The system of claim 13, further comprising adding at least one of newly created web page thumbnails and newly modified web page thumbnails to at least one of the library or another library for subsequent access and use.

20. The system of claim 13, wherein the extensible web page thumbnail framework supports widget drop and drag functions to apply one or more of the widgets to a given web page thumbnail.
